(19) United States
(12) Patent Application Publication
(10) Pub. No.: US 2008/0272624 A1
(43) Pub. Date: Nov. 6, 2008

(54) RETRACTABLE ROOF LUGGAGE RACK

(75) Inventor: Daniel DONICKE, Heppenheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/113,830

(22) Filed: May 1, 2008

(30) Foreign Application Priority Data
May 4, 2007 (DE) 102007020917.9

(51) Int. Cl. B60J 7/02

(52) U.S. Cl. 296/216.01

(57) ABSTRACT

A roof is provided with support elements of a roof load carrier that can swivel into a roof channel. The roof load carrier is used by swiveling the support elements out of the roof channel into a position projecting over the outer skin of the roof. The free ends of the support elements exhibit receiving means for attachment to a transverse carrier of the roof load carrier. When the roof load carrier is not in use, only the transverse carriers are disassembled and taken along in a corresponding hold in the motor vehicle.

### CROSS-REFERENCE TO RELATED APPLICATION

This application claims priority to German Patent Application No. 102007020917.9, filed May 4, 2007, which is incorporated herein by reference in its entirety.

### TECHNICAL FIELD

The invention relates to a roof for a motor vehicle with an outer roof skin and support elements for a roof load carrier.

### BACKGROUND

A roof for a motor vehicle with an outer roof skin and support elements for a roof load carrier is often used in modern motor vehicles, and is known from practice. The roof known from practice exhibits a roof load carrier opening arranged in the outer roof skin, which is covered by a cover with the roof load carrier not assembled. The cover can be moved to the side or folded away. Situated under the cover are mounting means, to which the support elements of the roof load carrier can be secured.

However, the disadvantage to the known roof is that the roof load carrier should be dismantled when not in use, since this adversely affects the aerodynamics and fuel consumption of the motor vehicle. As a result, the roof load carrier must be stored away when not in use, which is expensive. In addition, the roof load carrier is not available at all times.

At least one object of the invention is to further develop a roof of the kind mentioned at the outset in such a way that a device for carrying loads on the roof is available at all times, and does not adversely affect the aerodynamics or fuel consumption when not in use. In addition, other objects, desirable features, and characteristics will become apparent from the subsequent summary, detailed description and the appended claims, taken in conjunction with the accompanying drawings and this background.

### SUMMARY

This object, and other objects, desirable features, and characteristics, is achieved according to an embodiment of the invention by virtue of the fact that the support elements can be moved from a position retracted in the roof, in which the support elements are arranged under the roofline generated by the outer roof skin, into a position that projects over the outer roof skin.

As a result of this configuration, the support elements of the roof load carrier are an integral constituent of the roof according to an embodiment of the invention, and hence available at all times. To use the roof load carrier, the support feet are simply moved into the projecting position. However, since the support elements can simply be moved to the retracted position with the roof load carrier not in use, the adverse affect on the aerodynamics or fuel consumption is reliably avoided.

The space required by the support elements can be kept particularly low in another advantageous further embodiment of the invention by having the support elements telescope into vertical columns of the roof. Since the vertical columns often referred to as A, B and C columns are usually hollow, no extra structural space is required for the support elements. When retracted in the roof, the support elements also enhance the stability of the vertical columns in their regions adjacent to the roof.

The roof according to an embodiment of the invention has an especially simple structural design if the support elements are hinged in the roof.

In another advantageous further embodiment of the invention, the support elements in the retracted position are especially easy to access if the support elements can be swiveled in along a roof channel pointing along the traveling direction of the motor vehicle.

Disruptive irregularities in the roof according to an embodiment of the invention can be easily avoided by providing the roof or support elements retracted in the roof with a panel that is flush with the outer roof skin. This design reliably prevents the support elements in the retracted position from adversely affecting the aerodynamics. Damage to the panel during load transport is avoided by having the roof exhibit the panel.

In another advantageous further embodiment of the invention, various types of roof load carriers can be arranged on the support elements if the free ends of the support elements standing away from the outer roof skin in the deployed position exhibit receiving means for connecting with a transverse carrier of the roof load carrier arranged transverse to the traveling direction of the motor vehicle. Another advantage to this embodiment is that recesses in the roof outer skin for the roof load carrier can be very small, since the transverse carrier is secured separately to the support elements in the deployed position. Because the transverse carriers of roof load carriers are usually long stretched out and straight components, the can be included on corresponding mounts in the motor vehicle while saving on space. The transverse carriers are preferably joined with the support elements by means of latching means that can be detached without tools.

In another advantageous further embodiments of the invention, the subsequent assembly of a transverse carrier can be easily avoided by joining the support elements with a trans-verse carrier, and by retracting the transverse carrier in the roof with the support elements in the retracted position. This design moves the entire roof load carrier from the retracted position into the deployed position when required. In the retracted position, the transverse carriers help to reinforce the roof according to this embodiment of the invention.

In another advantageous further embodiment of the invention, the support feet are moved from the retracted position to the deployed position in an especially convenient way by means of an actuator to drive the support elements, and a control element to control the actuator. Such actuators can have an electric motor or hydraulic motor, for example, and be manually activated with a key. As an alternative, the actuator can also be designed as a spring element, and pre-load the support elements in the deployed position. The support elements can then be held in the retracted position by means of a manually detachable latching connection.

In another advantageous further embodiment of the invention, the roof load carrier is supported in an especially convenient manner if the support elements have latching elements or stop means to provide support in their deployed position.

### BRIEF DESCRIPTION OF THE DRAWINGS

The present invention will hereinafter be described in conjunction with the following drawing figures, wherein like numerals denote like elements, and

FIG. 1 shows a motor vehicle roof vehicle according to the invention;

FIG. 1a shows the motor vehicle roof according to the invention from FIG. 1 with a roof load carrier;

FIG. 2 shows a highly magnified schematic sectional view through the motor vehicle roof according to the invention from FIG. 1 along the II-II line with a support element;

FIG. 3 shows a partial area of the roof according to the invention from FIG. 1 with assembled roof load carrier,

FIG. 4 shows a highly magnified schematic sectional view through the motor vehicle roof according to the invention from FIG. 1 along a column of the roof,

FIG. 5 shows a partial area of the roof according to the invention from FIG. 4 with assembled roof load carrier.

### DETAILED DESCRIPTION

The following detailed description is merely exemplary in nature and is not intended to limit the invention or the application and uses of the invention. Furthermore, there is no intention to be bound by any theory presented in the preceding background, summary, or the following detailed description.

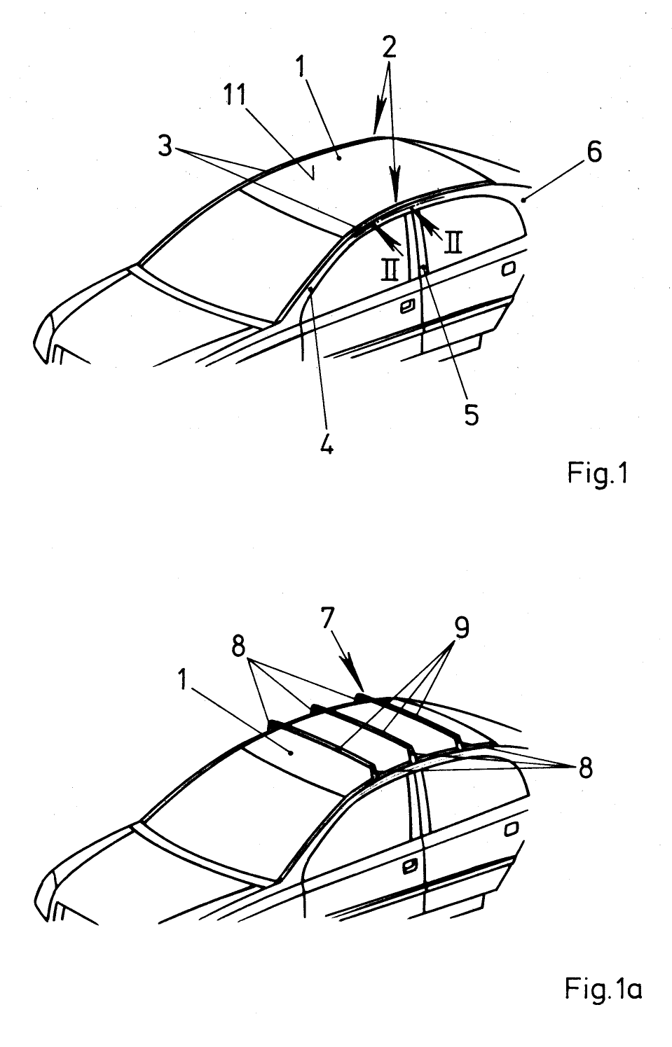

FIG. 1 shows a partial area of a motor vehicle with a roof 1 and two roof channels 2 extending laterally in the traveling direction. The roof channels 2 are covered by a cover strip 3. The roof 1 is secured by several vertical columns 4 to remaining areas of a motor vehicle body. FIG. 1a shows the roof 1 from FIG. 1 with a roof load carrier 7. The roof load carrier 7 exhibits several support elements 8 arranged on the roof 1. Two respective support elements 8 are joined together by means of a transverse carrier 9.

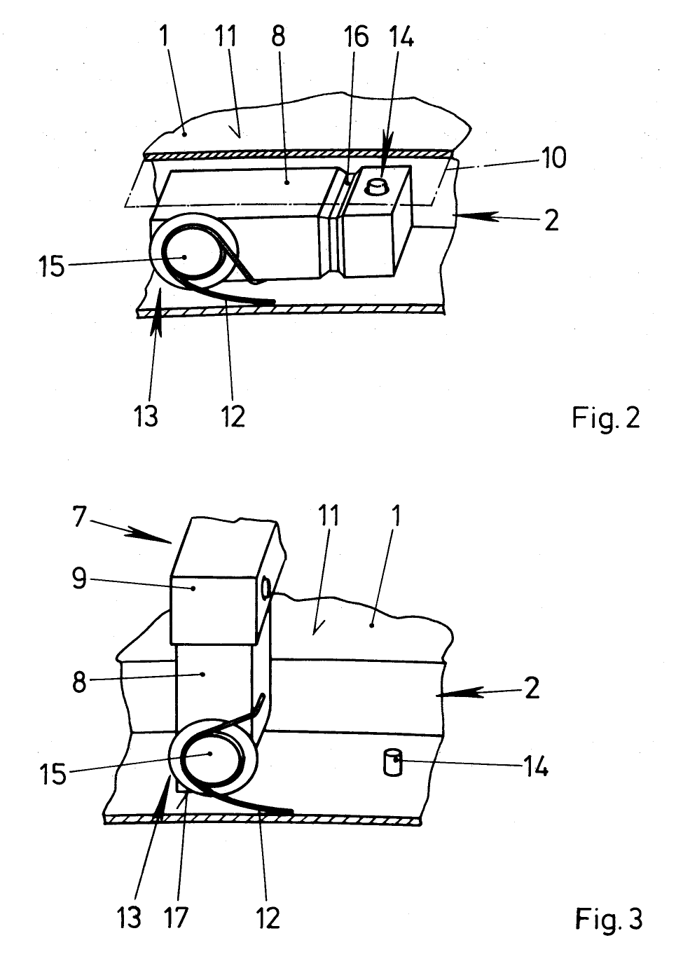

As FIG. 2 shows in a highly magnified sectional view through a partial area of one of the roof channels 2 from FIG. 1, the roof 1 has a movable panel 10. One of the support elements 8 of the roof load carrier 7 shown on FIG. 1a is pivoted under the panel 10. The panel 10 ends flush with an outer skin 11 of the roof 1, and covers the support element 8 swiveled into the roof channel 2. The support element 8 is pre-loaded counterclockwise by an actuator 13 exhibiting a spring element 12, and held in position by a latching element 14 arranged in the roof channel 2. The end of the support element 8 facing away from a mount 15 has receiving means 16 for attachment with the transverse carrier 9 of the roof load carrier 7. After the latching element 14 is detached, the force of the spring element 12 pivots the support element 8 counterclockwise into a deployed position.

FIG. 3 shows the support element 8 in the position projecting over the outer roof skin 11. In this position, the support element 8 is braced by stop means 17, and the transverse carrier 9 can be latched onto the receiving means 16 on the free end of the support element 8. The transverse carrier 9 joins two support elements 8 arranged on opposing longitudinal sides of the roof 1. Loads can be arranged and transported on the transverse carriers 9 of the roof load carrier 7. If the roof load carrier 7 is not required, the transverse carriers 9 are disassembled and stowed in a corresponding hold in the motor vehicle. The support elements 8 can be swiveled back into the roof channels 2, as depicted on FIG. 2, and the panel 10 can be moved over the support elements 8.

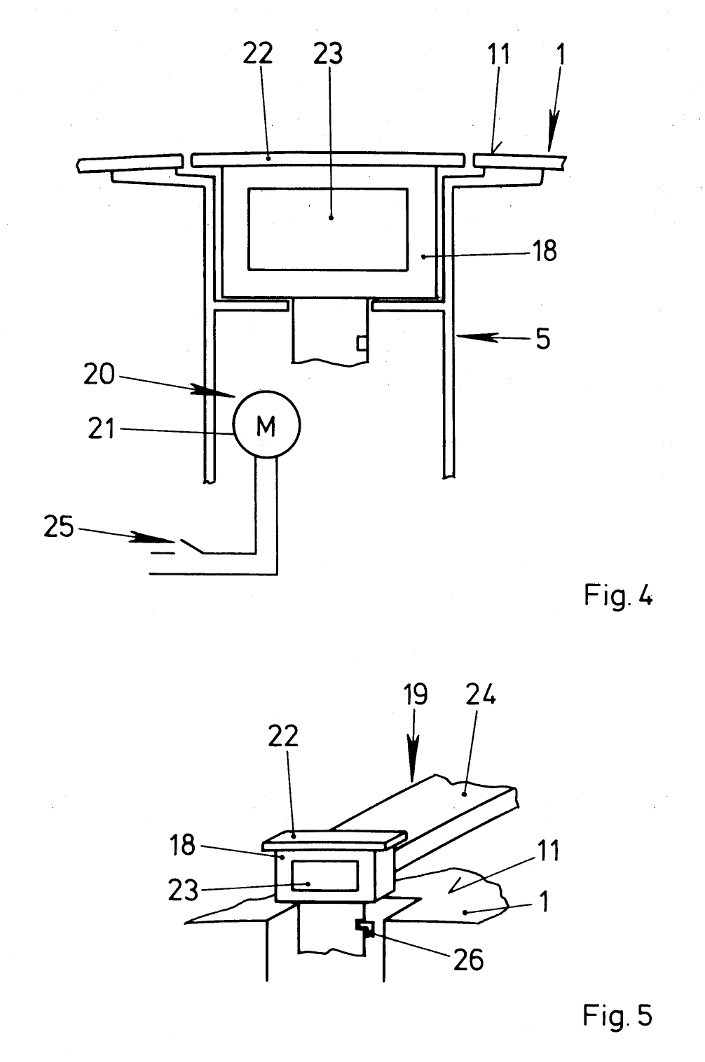

FIG. 4 shows another embodiment of the roof 1 depicted on FIG. 1 in a longitudinal section along a central column 5. The central column 5 incorporates a support element 18 of a roof load carrier 19 shown partially on FIG. 5, which can be vertically moved by means of an actuator 20 with an electric motor 21. The support element 18 carries a panel 22 that ends flush with the outer roof skin 11 at its free end, and has receiving means 23 for attachment with a transverse carrier 24 depicted on FIG. 5. The electric motor 21 can be activated via a control element 25, thereby moving the support element 18 from the retracted position shown on FIG. 4 into a position projecting over the outer roof skin 11 as depicted on FIG. 5. In the deployed position, the support element 18 is held by a latching means 26. Otherwise, the roof load carrier 19 is designed like the one on FIG. 1a.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A roof for a motor vehicle, comprising:
an outer roof skin; and
a plurality of support elements for a roof load carrier,
wherein the plurality of support elements can be moved from a position retracted in the roof arranged under a roofline of the roof generated by the outer roof skin into a position that projects over the outer roof skin.

2. The roof according to claim 1, wherein the plurality of support elements can telescope into vertical columns of the roof.

3. The roof according to claim 1, wherein the plurality of support elements are hinged in the roof.

4. The roof according to claim 1, wherein the plurality of support elements can be swiveled in along a roof channel pointing along a traveling direction of the motor vehicle.

5. The roof according to claim 1, wherein the roof exhibits a panel flush with the outer roof skin when retracted in the roof.

6. The roof according to claim 1, wherein the plurality of support elements exhibit a panel flush with the outer roof skin when retracted in the roof.

7. The roof according to claim 1, wherein free ends of the plurality of support elements standing away from the outer roof skin in a deployed position exhibit receiving means for connecting with a transverse carrier of the roof load carrier arranged transverse to a traveling direction of the motor vehicle.

8. The roof according to claim 7, wherein the plurality of support elements are joined with a transverse carrier is retracted in the roof with the plurality of support elements in a retracted position.

9. The roof according to claim 1, wherein the plurality of support elements can be driven by an actuator, and a control element can be used to control the actuator.

10. The roof according to claim 1, wherein the plurality of support elements have latching elements to hold them in a deployed position.
